(19) United States
(12) Patent Application Publication
(10) Pub. No.: US 2009/0287415 A1
(43) Pub. Date: Nov. 19, 2009

(54) SYSTEMS, DEVICES AND METHODS FOR INCREASING LOCATION BASED SERVICE ACCURACY

(75) Inventors: Christian A. Buerger, Woodland Hills, CA (US); Gregory P. Hayes, Santa Monica, CA (US); Yong Jin Woo, Los Angeles, CA (US); Chuljin Ahn, Los Angeles, CA (US)

Correspondence Address: FENWICK & WEST LLP, SILICON VALLEY CENTER, 801 CALIFORNIA STREET, MOUNTAIN VIEW, CA, 94041, US

(73) Assignee: Helio, LLC, Los Angeles, CA (US)

(21) Appl. No.: 12/121,187

(22) Filed: May 15, 2008

(51) Int. Cl. G01C 21/00

(52) U.S. Cl. 701/300

(57) ABSTRACT

A method of increasing location based service accuracy by correcting location data associated with a fixed source using a mobile communication device. The method includes the step of receiving, on the mobile communication device, a first set of location data. The first set of location data is originated from the fixed source such that if the location data is accurate, a physical location of the mobile communication device can be determined. The fixed source has a stored physical address which is updateable by an operator. At least a portion of the first set of location data derives from the stored physical address. The method further includes the steps of determining whether the first set of location data is accurate, and transmitting an error report to the operator when the first set of location data is inaccurate.

### FIELD OF THE INVENTION

The invention relates to the field of location determination using electronic devices. Specifically, the invention relates to systems, devices, and methods for improving the accuracy of a location based service available on an electronic device.

### BACKGROUND OF THE INVENTION

Many mobile communication devices are equipped to receive or otherwise provide information about their locations. One of the available location based services relies on cell-IDs to estimate the location of a mobile device. Specifically, by using the cell-ID of a cellular tower, and various processing and data transmission steps, relatively fast indication of mobile device location can be achieved. It is important to note that the cellular towers used to provide such a service are fixed in space with their own spatial coordinates or another indicator of a physical address.

Typical mobile location based services include mapping an address, giving directions from point A to point B, and navigating based on the directions. A common problem in the provision of these mobile location based services is that the information obtained from the cellular network may be inaccurate. This may result in an unsatisfactory experience for a mobile device user who is trying to determine his current location or find his way to a particular address. For example, if the mobile device displays the user's current location as somewhere in the middle of the Atlantic Ocean, instead of his actual location in downtown Los Angeles, Calif., or simply displays an error screen, that user will be frustrated and unlikely to use the LBS features of his mobile device. Even worse, the user may return the device or place a costly service call to attempt to resolve the issue. In some instances, as discussed below, service calls alone cannot address the underlying problem.

The inaccuracy in the location information obtained by a mobile device often results from an error at the cellular tower level. If the location associated with one or more fixed towers is incorrect, it follows that when the cell-ID of the tower is used to estimate the current location of the mobile-device user, any such estimate will be wrong.

For example, the positioning coordinates of the cellular tower may be unavailable. As a result, the default latitude/longitude coordinates 0/0 is transmitted to the mobile device in response to a request for location data. When these coordinates are reformatted and displayed on the mobile device, it informs the user that he is somewhere in the Atlantic Ocean, or otherwise displays an error message. In turn, this results in a frustrating experience for the user. User dissatisfaction can lead to increased churn and customer support costs for the device supplier or a mobile operator offering the device. This requires additional resources, e.g., a trouble-shooting call center, that may be expensive. In addition, the mobile operator likely would have to reimburse the cost of the location determination service to the user as a result of the poor quality of the service.

Currently, monitoring cellular towers for error is accomplished through field testing where a field technician drives to different test spots to record location coordinates and then manually evaluates the accuracy of those coordinates. This is inefficient and costly. Finally, the mobile operator needs to provide real-time customer support for dissatisfied customers who have received inaccurate location based service.

The present invention provides systems, devices, and methods that address the above-mentioned problems by providing a solution for increasing the accuracy of location based service on a mobile device.

### SUMMARY OF THE INVENTION

In one aspect, the invention relates to systems, devices, and methods that improve the accuracy of a location based service by identifying and/or remedying errors associated with data sources that have incorrect spatial coordinates or addresses.

In aspect of the invention, a method of increasing location based service accuracy by correcting location data associated with a fixed source is provided. In one embodiment, the method includes the steps of receiving, on a mobile communication device, a first set of location data; determining whether the first set of location data is accurate; and transmitting an error report to the operator if the first set of location data is inaccurate. In this embodiment, the first set of location data originates from the fixed source such that if the location data is accurate, a physical location of the mobile communication device can be determined. The fixed source has a stored physical address which is updateable by an operator, wherein at least a portion of the first set of location data derives from the stored physical address. In another embodiment, the first location source is a cellular tower and the operator is a cellular network provider. In yet another embodiment, the method further includes the step of obtaining a second set of location data from a second location source if the first set of location data is inaccurate. In yet another embodiment, the second location source is a GPS.

In another aspect, a method of verifying location information received on a mobile device is provided. In one embodiment, the method includes the steps of obtaining a set of location data from a location data provider; forwarding the set of location data to a location server; verifying, by the location server, whether the set of location data is valid; and forwarding the set of location data to the mobile device if the set of location data is determined to be valid. In another embodiment, the method further includes the step of logging the set of location data if the set of location data is determined to be invalid. In yet another embodiment, the method further includes the step of logging an identifier of the location data provider. In yet another embodiment, the method further includes the step of notifying the location data provider of the invalid set of location data. In yet another embodiment, the method further includes the step of requesting correction of the set of location data from the location data provider.

In yet another embodiment, the set of location data is selected from the group consisting of latitude date, longitude data, altitude data, and a street address. In yet another embodiment, the step of verifying further comprises performing a multi-dimensional validity check. In yet another embodiment, the number of dimensions in the multi-dimensional validity check corresponds to the number of coordinates in the set of location data. In yet another embodiment, the set of location data is cellular network data. In yet another embodiment, the cellular network data relates to the Cell ID of a cellular tower. In yet another embodiment, the method further includes the steps of converting the set of location data to a format suitable for displaying on the mobile device and displaying the converted set of location data on the mobile device.

In yet another aspect, a system for obtaining valid location information is provided. In one embodiment, the system includes a location source configured to provide a set of location data; a mobile device configured to receive and display the set of location data from the location source; a location server in communication with the mobile device and configured to validate the set of location data; and a ticketing server in communication with the location server and configured to track the set of location data, the validity of the set of location data, and the location source by which the set of location data is provided. In this embodiment, the mobile device displays the set of location data only after the set of location data is determined to be valid by the location server.

### BRIEF DESCRIPTION OF THE DRAWINGS

These embodiments and other aspects of this invention will be readily apparent from the detailed description below and the appended drawings, which are meant to illustrate and not to limit the invention, and in which:

FIG. 1A is a functional block diagram that illustrates the components of an exemplary system that includes multi-mode location determining network interface components and software for practicing an embodiment of the present invention;

FIG. 1B is a diagram illustrating a system for determining the location of a mobile device using one or more location services or associated networks, according to an embodiment of the invention;

FIG. 2 is a diagram illustrating the components of a mobile device which may be used to obtain location information, according to an embodiment of the invention;

FIG. 3 is a flow diagram that illustrates Cell-ID location determination logic, according to an embodiment of the invention;

FIG. 4 is a flow diagram that illustrates MS-Assist location determination logic, according to an embodiment of the invention;

FIG. 5 is a diagram that illustrates components of a location service network suitable for increasing location based service accuracy on a mobile device, in accordance with an embodiment of the invention; and

FIG. 6 is a flow diagram that illustrates the steps of detecting and reporting an error in location information, in accordance with an embodiment of the invention.

### DETAILED DESCRIPTION OF THE PREFERRED EMBODIMENTS

The present invention will be more completely understood through the following detailed description, which should be read in conjunction with the attached drawings. In this description, like numbers refer to similar elements within various embodiments of the present invention. Within this detailed description, the claimed invention will be explained with respect to preferred embodiments. However, the skilled artisan will readily appreciate that the methods and systems described herein are merely exemplary and that variations can be made without departing from the spirit and scope of the invention.

Embodiments of the invention provide a solution for improving the quality of a location based service (LBS) available on mobile devices. Specifically, when a user activates an LBS, such as a point of interest search, in some instances an error may result such that the mobile device displays an erroneous result or an error message to the user. This problem can be caused by different issues. However, in many instances the erroneous result or error message is caused because the source of the location data, often fixed cell towers, are not properly addressed with respect to location. That is, if a particular cell tower is supposed to have a spatial (x,y,z) address of (2333, 1544, 1000) or something more straightforward such as 10960 Wilshire Blvd, it is often the case that the cell tower's physical address was never set by its operator or otherwise set to an incorrect address. If the default address for such a cell tower is (0,0,0), it is clear that the deviation from (2333, 1544, 1000) would preclude an LBS system from identifying any user that relied on that cell tower.

In part, the embodiments of the invention use a mobile device to capture and report inaccurate location data to an operator in control of the source of the location data. In one embodiment, the location data source is a fixed source having a stored physical address which is updateable by the operator. The location data source sends a set of location data stored in the physical address to the mobile device upon receiving a request to use an LBS service. The mobile device uses the data to determine its physical location and displays it to the user. If the location data is inaccurate, an error report is transmitted to the operator so that the operator can update the location data source's positional address.

Embodiments of the invention are configured to work with various location determination technologies. Suitable location determination technologies include Cell-ID, Mobile Station Assist Method (MS-Assist), and any other technologies that use a fixed location source for transmitting location data to a mobile device.

Cell tower based location determining methods estimate the location of a mobile device by relating a cell ID of a cell tower to spatial coordinates or another indicator of a physical address recorded associated with the tower. The cell tower serves as the fixed location source that obtains and records its own coordinates and forwards those coordinates to a mobile device when requested. Typically, cell-ID operates with a granularity that is too coarse to predict device location with a high accuracy, but the computation is fast. Further identifying device position relative to a given cell tower is sufficient for many applications.

When compared to cell-ID, MS-Assist provides slower, but more precise location data by communicating between the mobile device or mobile station and a position determination entity (PDE). Because response time for MS-Assist is in seconds, it has been used for a single fix application such as in geographic information systems (GIS) data lookup.

Regardless of which location determination technology is in use, a problem exists when the location source, e.g., the cellular tower, does not have the correct coordinates for its own location. This could happen if the cellular tower fails to communicate with the GPS. It could also be that the coordinates were reset during maintenance of the cellular tower. Because the cellular tower does not maintain a live connection with the GPS satellites and requires a periodic feed from the satellite or manual input to obtain its own GPS coordinates, the tower itself has no way of detecting whether it has the incorrect coordinates before forwarding them to the mobile devices. Embodiments of the invention, as discussed in more detail below, provide a feedback loop so that the operator in control of the fixed location data source is informed about any incorrect coordinates originated from the particular location data source (e.g. cell tower) and can take measures to fix the problem. In turn, this enhances the user experience and the integration of their mobile device in all facets of their lives.

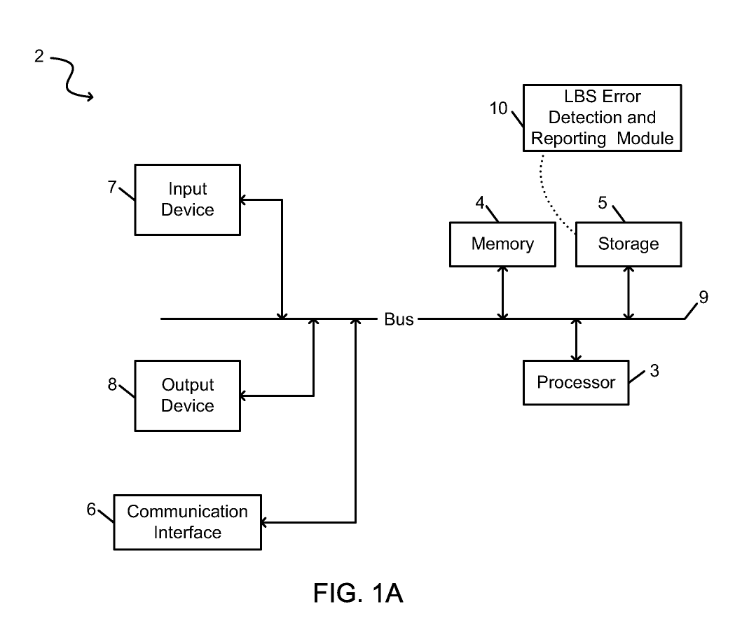

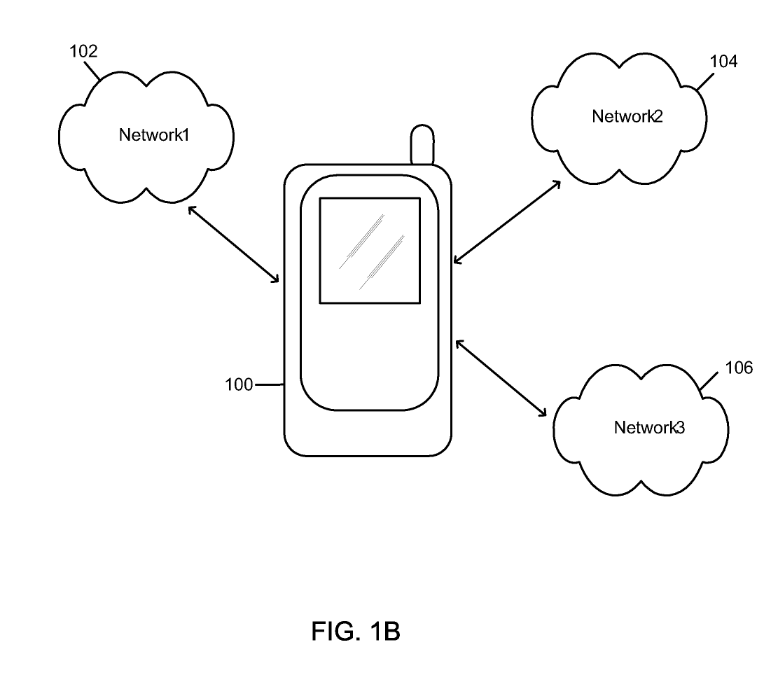

In the following discussion of illustrative embodiments, a “mobile device” includes, without limitation, mobile phones, remote control devices, personal digital assistants, hand-held computers, ultra-mobile personal computers, and the like. FIG. 1A is a functional block diagram that illustrates the components of an exemplary mobile device 2 for practicing an embodiment of the present invention. Mobile device 2 preferably includes a processing unit or processor 3, a system memory 4, a disk storage 5, a communication interface 6, an input device 7, an output device 8, and a system bus 9. System bus 9 couples system components including, but not limited to, system memory 4 to processing unit 3. The processing unit 3 can be any of various available processors. A location based systems (LBS) error detection and reporting module 10 is also shown. The LBS error detection and reporting module 10 can include various data elements and programs suitable for performing the process steps and calculations with respect to receiving and processing location data from a location source. In one embodiment, the LBS error detection and reporting module 10 is also configured to determine the accuracy of the received location data.

Input device 7 may be a keyboard, thumbboard, or touchscreen that are used to receive data from a user. In addition, input device 7 can also include a plurality of other inputs or controls for adjusting and configuring one or more aspects of the present invention including voice commands. Output device 8 may be a display device, such as an LCD or LED display screen, that can display one or more display objects (not shown) such as configurable icons, buttons, input boxes, menus, tabs, key labels and so forth having multiple configurable dimensions, shapes, colors, text, data and sounds to facilitate operations with mobile device 2.

Communication interface 6 facilitates data exchange over a variety of wireless networks. In various embodiments of the invention, the communication interface 6 is also configured to communicate with a location server (or software installed on the device 2) that analyzes and validates the location data received by the mobile device 2. The location server is discussed in more detail below. In addition, the communication interface 6 can also include a plurality of components or operational features that allow the communication device to select between a plurality of location services as outlined below. For example, communication interface 6 may correspond to a cellular LBS module, while other components of the interface (not shown) may correspond to Wi-Fi LBS and traditional GPS or enhanced GPS modules, respectively. The hardware and software necessary for connection to the communication interface 6 includes, for exemplary purposes only, internal and external components that transmit and receive data wirelessly using a plurality of standard protocols including, for example, GSM, CDMA, W-CDMA, Bluetooth, Wi-Fi, IrDA, WiMAX, WiBRO or through other known wireless standards.

Storage 5 may include removable or fixed, volatile or non-volatile or permanent or re-writable computer storage media. The computer readable medium can be any available medium that can be accessed by a general purpose or special purpose mobile device. By way of example, and not limitation, such a computer readable medium can comprise flash memory, RAM, ROM, electrically erasable programmable read only memory (EEPROM), optical disk storage, magnetic disk storage or other magnetic storage devices, or any other medium that can be used to store digital information on a mobile device.

It is to be appreciated that FIG. 1A describes software that acts as an intermediary between users and the basic resources described in mobile device 2. Such software preferably includes an operating system. The operating system, which can be resident in storage 5, acts to control and allocate resources of mobile device 2. System applications take advantage of the management of resources by the operating system through program modules and program data stored either in system memory 4 or on disk storage 5. Furthermore, it is to be appreciated that the present invention can be implemented with various operating systems or combinations of operating systems.

The computer readable medium tangibly embodies a program, functions, and/or instructions that cause the computer system to operate in a specific and predefined manner as described herein. Those skilled in the art will appreciate, however, that the process described below relating to location detection as well as other features recited herein, may be implemented at any level, ranging from hardware to application software and in any appropriate physical location. For example, the location determination, reporting, and/or correction process may be implemented as software code to be executed by mobile device using any suitable computer language and may be stored on any of the storage media described above, or can be configured into the logic of mobile device 2. Such software code may be executed by mobile device using any suitable computer language such as, for example, Java, Javascript, C++, C, C#, Perl, Visual Basic, Transact/Structure Query Language (T/SQL), database languages, APIs, various system-level SDKs, assembly, firmware, microcode, and/or other languages and tools.

These are representative components of a mobile device whose operation is well understood. Furthermore, those of ordinary skill in the art will appreciate that mobile device 2 of FIG. 1A is exemplary only and that the present invention can operate within a number of different mobile devices.

FIG. 1B illustrates the components of an exemplary mobile device 100 for practicing an embodiment of the present invention. In the illustrated embodiment, the mobile device preferably includes a display, a processor, a keypad, and one or more network interface components configured to access a plurality of location determination services associated with multiple networks using a network interface/communication interface.

Specifically, FIG. 1B illustrates a mobile device 100 in communication with multiple networks 102, 104, 106. Each of the three networks shown is associated with at least one location based service (LBS). In various embodiments, the mobile device 100 may be a mobile phone (as illustrated), personal digital assistants, hand-held computers, ultra-mobile personal computers, and the like. The mobile device includes a communication subsystem configured to communicate with the multiple networks 102, 104, and 106. An example of such a device is a dual mode 802.11/cellular phone, which is capable of receiving Wi-Fi signals in addition to the basic cellular network signals.

Given the geographic placement of Wi-Fi hotspots and the cells associated with different towers and base stations used for cellular phone service, both cellular services and Wi-Fi services can be used as location determination services in accordance with the teachings described herein. Thus, a mobile device with GPS, Wi-Fi, and cellular capabilities can act as a multi-mode location determining device. However, the term dual mode or multi-mode is not limited to a particular grouping of networks or service types. Thus, multi-mode can refer to the ability of the mobile device to access two or more location determination services such as a LBS and/or their associated location data providing services.

Each of the networks 102, 104, 106 provides a location service that allows the user of the mobile device 100 to determine his or her current location and calculate directions to specified destinations. The networks 102, 104, 106 each utilize different Open Systems Interconnection (OSI) Layer 1 and Layer 2 technologies. For example, network 1 102 may be an IEEE 802.11 Wi-Fi network, network 2 104 may be a cellular network that utilizes the device's position relative to different cells to generate positional information, or it may be an enhanced service that combines cellular data with GPS data to provide location service, and network 3 106 may be a IEEE 802.16e WiMAX network. The location information may come from any of the networks based on the availability of the networks and preprogrammed fallback logics that are designed to optimize the location service.

When the device 100 is within a particular range of some or all of the networks 102, 104 and 106, the device 100 is programmed to automatically select a network based on a predetermined ranking of the networks or other criteria such as the availability of LBS. The LBS criteria can be a function of the particular software application that is collecting the location data on the device 100. Because the networks 102, 104, 106 are based on different technologies, each has its own advantages over the others. For example, the Wi-Fi network 102 based location service is more accurate and less expensive than the other service, but the wireless network based service may be more ubiquitous than the Wi-Fi based service. The mobile device 100 may also provide the option of allowing the user to set a default location service and manually switch to a different one when necessary. Network selection and fallback logics will be further discussed below.

As mentioned above, to communicate with the different networks 102, 104, 106, the mobile device 100 can be a multi-mode device configured with multiple network interfaces, one for communicating with each location service network. This is because that the networks 102, 104, 106 are built based on different standards and have different protocols. Consequently, a device 100 capable of communicating with the networks 102, 104, 106 has to be able to switch between the different modes to transmit data in the format compatible with a particular network. One existing multi-mode device is the aforementioned dual-mode 802.11/cellular phone. A typical dual-mode 802.11/cellular phone has most of the common features of a cell phone, including one or more keypads, at least one screen, a speaker, a microphone and an antenna. What distinguish the dual-mode phone from an ordinary phone are the additional components it has which allow it to switch between different networks when in use.

In one embodiment, the present invention utilizes the mode-switching capability of such dual-mode devices for the purpose of obtaining accurate location data. For instance, when inaccurate location data from one of the networks, e.g., a cell-ID based cellular network, is detected and captured, the mobile device 100 automatically switches to a second network, e.g., the GPS, for obtaining the correct current location data. This allows the mobile device to be able to avoid any significant downtime in its location service. The mobile device may optionally switch back to the original network once the original network is able to provide accurate location data. Generally, the aspects and embodiments described herein are extendible to any multi-mode device that can (1) switch between networks in response to processor and software instructions and (2) collect location data from an LBS. However, single mode devices are suitable for all of the methods disclosed herein.

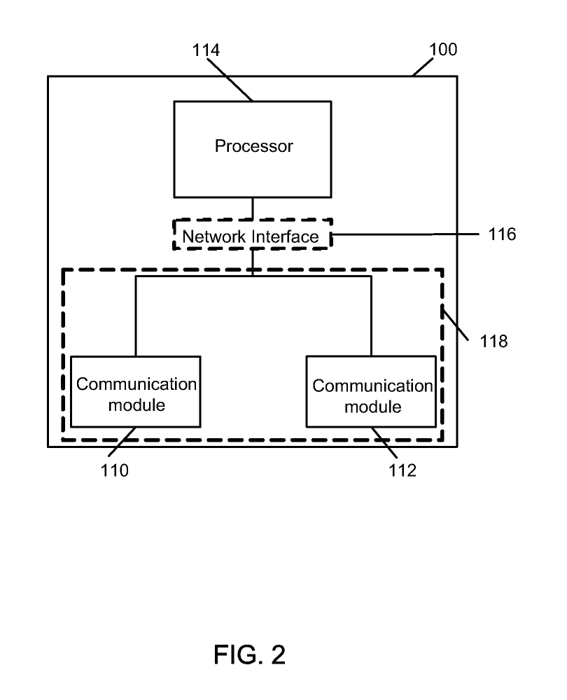

FIG. 2 illustrates components of an exemplary device 100, such as a dual-mode wireless device, suitable for retrieving location data from different networks, according to one embodiment of the invention. Referring to FIG. 2, the device 100 includes a processor 114, an optional network interface component 116 and a communication subsystem 118. In one embodiment, the network interface component can be part of, or comprise the entire subsystem 118. The processor 114 processes a user request for location service, selects a network from substantially all compatible networks, and forwards the request to the selected network. The network interface component 116 serves as a gateway between the processor 114 and the communication subsystem 118. The network interface component 116 can convert the request into the correct data format compatible with the network selected by the processor 114 and for passing the formatted request to the corresponding communication subsystem 118.

Within the device embodiment depicted in FIG. 2, the communication subsystem 118 may further include two communication modules 110, 112, each configured to send and receive information to and from its corresponding network. In some embodiments, additional communication modules can be used for a multi-mode device. For example, when the 802.11 Wi-Fi network is selected by the processor, the request for location service data is passed to the first communication module 110. The first communication module 110 then searches for an available Wi-Fi location service network in the area. These two module 110, 112 can be implemented as software resident in memory in some embodiments. If one is found, the first communication module 110 transmits the request to the Wi-Fi network and receives the location data back from the Wi-Fi based location service. The location data may be in the format of latitude, longitude and altitude coordinates, or in any format that can be processed by the processor 114 of the device 100. The different communication subsystems also monitor the active network or active LBS service to determine if a switch to a new network is required.

In this example, if no Wi-Fi network is detected by the first communication module 110 in a limited time period, the first communication module 110 reports the timeout event to the processor 114 which then resends the request to the second communication module 112. The second communication module 112 then initiates a search for a cellular signal from a cellular network which provides location data or another cellular based position information. If the cellular network is available, the request is transmitted by the second communication module 112 via the cellular network to obtain the generated location coordinates. The coordinates are transmitted back to the second communication module 112 via the cellular network. Similarly, the second communication module 112 then forwards the location data back to the processor 114. In various devices, the communication modules 110, 112 may be hardware components such as application-specific integrated circuits, or implemented by software applications or libraries stored in the memory (not shown) of the device 100. Alternatively, the first communication module can first initiate a Cell-ID data request while the second module is initiating a MS-Assist or MS-Based approach.

The location data is first converted by the network interface component 116 to a format recognizable by the processor 114. The processor 114, upon receiving the data, may either format the data for displaying on the screen of the cellular device 100 or send it to various applications stored in the memory, for example, to generate precise location or turn-by-turn direction by applying one or more successive location determination algorithms.

The network interface component 116 employs a variety of GPS-based, cellular and Wi-Fi based location determination technologies and systems in conjunction with the existing cellular location determination technologies. Location determination technologies suitable for embodiments of this invention include, but are not limited to, cell-ID, Mobile Station Based Method (MS-Based), and any other such technology that utilizes a fixed location data source. The following paragraphs provide a more detailed description of how some of these technologies, i.e., cell-ID and MS-Assisted location services, work.

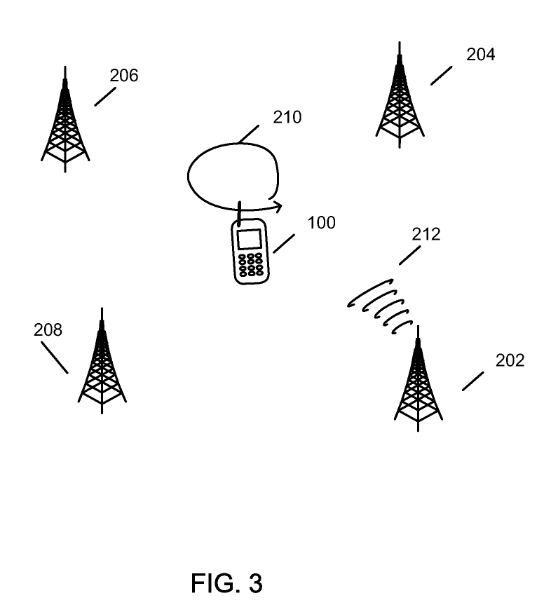

As illustrated in FIG. 3, cell-ID technology is based on obtaining location information from the nearest cell tower 202 to determine the location of the mobile device 100. It is a process in which the device location is tracked through cell tower locations. Typically, a mobile device 100 searches for cell towers 202, 204, 206 and 208 around its area. The communication subsystem 118 sends a signal 210 to alert a cellular tower 202 (often to the nearest cellular tower) that the device 100 is in the cell served by that tower 202. The cellular tower 202, in turn, sends a signal 212 to the device's communication system 118 to notify the wireless device 100 that it is in the cell corresponding to that cellular tower 202. The wireless device 100 picks up the strongest and least traffic cell tower 202. In connecting to that cell tower 202, cell tower 202 sends its own location in latitude and longitude. From this information, location information can be determined approximately where the mobile device is located.

When the cell-ID technology is used to obtain location data. The fixed location data source is the cellular tower 202 that sends the latitude and longitude coordinates. However, when the cellular tower does not have the correct coordinates for its location, the location of the mobile device calculated from those coordinates is also incorrect. To receive the correct information and improve usability, the incorrect coordinates and an unique identifier of the cellular tower 202 responsible for sending the coordinates are reported, by the mobile device 100, to database or directly to an operator in control of the cellular tower 202 so that the operator can load the correct coordinates of the tower and have the coordinates transmitted to the mobile device. If, for some reason, the operator cannot have the cellular tower coordinates corrected within a short period of time, the mobile device will switch, either automatically or under the instruction of the user, to a different location service network, e.g., the GPS, to receive the correct location data.

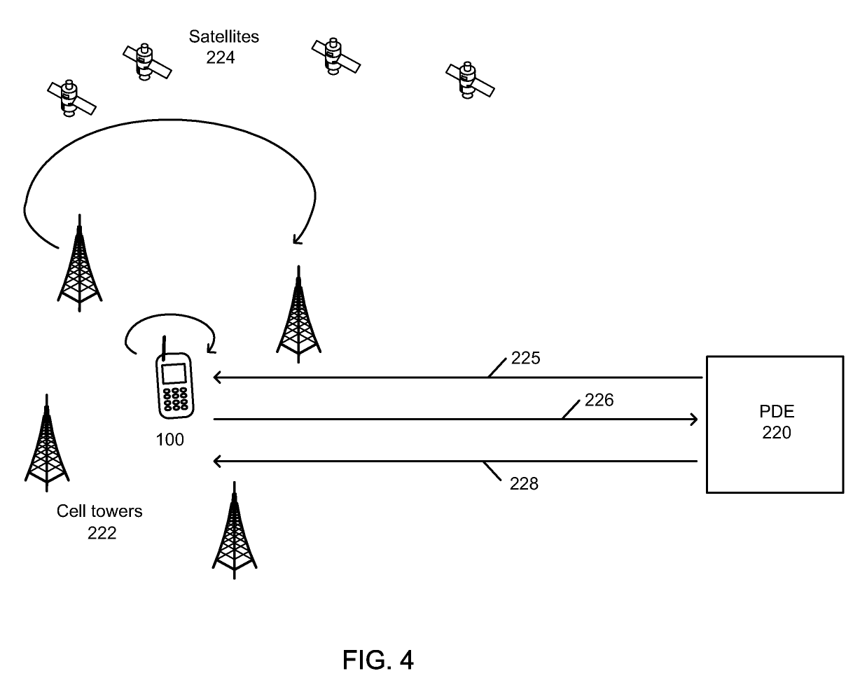

A MS-Assist based method is illustrated in FIG. 4, and uses GPS-aiding servers such as a Position Determining Entity (“PDE”) 220 to (1) track cell tower(s) 222 and satellite 224 information and/or (2) send location information to the mobile device 100. A PDE 220 is a system resource (e.g. a server) typically within a network, working in conjunction with one or more GPS reference receivers, which is capable of exchanging GPS related information with the cellular network. The location information is calculated inside the cellular network. PDE 220 provides GPS-aiding information 225 to the mobile device 100. Using the GPS-aiding information, the device 100 searches for satellites 224 and cell towers 222. The mobile device 100 sends the searched location 226 of satellites 224 and cell towers 222 to the PDE 220. The PDE 220 may compute the geographic location of the mobile device 100 from a plurality of (such as four or more) of the range measurements and send the geographic information 228 back to the mobile device 100.

Because the MS-Assisted method also relies on cellular towers 222 to provide the correct coordinates of the towers and the location of the mobile device 100 is calculated using these coordinates, incorrect coordinates of the cellular towers 222 often results in inaccurate location data for the mobile device 100. At any given moment, the mobile device in the MS-Assisted mode is only connected to one cellular tower, which provides the mobile device its location coordinates. As such, as in embodiments where cell-ID is used for providing location information, similar steps need to be carried out to improve the accuracy of the location information when the MS-Assisted method is used. Specifically, the mobile device 100 has to capture the incorrect coordinates of the cellular tower and the unique identifier of the tower 222 and report this information to a database for future updates or to the operator in control of the cellular tower 222 so that the operator can update the coordinates of the cellular tower 222.

Regardless of which location determining technology is used, as long as the mobile device receives location data from a fixed location source, the systems and methods disclosed in the various embodiments of this invention can be incorporated to improve the user experience associated with LBS applications, such as point of interest searching.

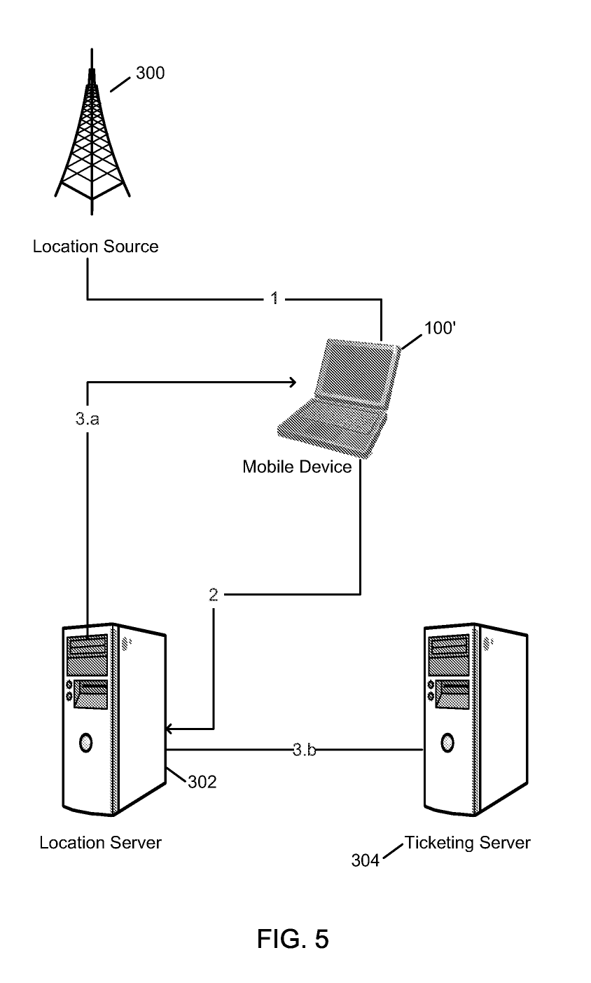

FIG. 5 is a diagram illustrating the various key components in a network that are suitable to track and report inaccurate location data, in accordance with an embodiment of the invention. The objective of the illustrated network is to allow individual location based applications on a mobile device 100′ to participate in automated reparation of defective location sources such as a source 300. The location source 300 provides latitude and longitude coordinates to the mobile device 100′. As discussed above, the location source 300 may be a cell tower. The coordinates corresponds to the location of the cell tower and can be used to estimate the location of the mobile device 100′.

When the mobile device 100′ receives the coordinates from the location source 300, the mobile device 100′ also requests a unique identifier for that location source 300. The unique identifier has to be recognizable by the operator of the location source 300 so that the operator can quickly look up relevant information or retrieve i.e., from a database of reported error logs, including the location of the location source 300, when it receives an error report from the mobile device 100. In one embodiment, before the coordinates from the location source 300 are used by any of the location service applications to provide direction and point of interests on a map, the mobile device 100′ first forwards the location coordinates to a location server 302 via a wireless network to be validated. Examples of the wireless network include the cellular network for the mobile device and any available Wi-Fi network.

The location server 302 analyzes the coordinates to determine that they are valid based on preset boundaries. For example, for a location based service in the U.S., coordinates outside of the geographic U.S. boundary would be considered invalid. Similarly, if the location based service is available throughout North America, the preset boundary would encompass other North American countries such as Canada and Mexico. In addition, the location server 302 may evaluate location coordinates based on other criteria. For example, the location server may invalidate a set of coordinates if the coordinates correspond to a location in the middle of a lake and the application on the mobile device is attempting to calculate driving directions from that location.

The location server 302 may simultaneously serve location data validation requests from multiple mobile devices. For example, one cellular network may use a single location server to handle all location data validation tasks. In various embodiments, the location server may be running Linux, MS Windows, Unix, Solaris, or any other operating systems suitable for providing the requisite functions such as location data validation.

If the coordinates are determined to be valid by the location server 302, the location server 302 notifies the mobile device 100′. The mobile device 100′ then forwards the coordinates to one or more of the location service applications to generate and display information, such as driving directions, requested by the user. As discussed in detail above, the location coordinates may have to be reformatted before they can be inputted into an application program. Various applications may require different formats.

If the coordinates are determined to be invalid by the location server 302, the location server 302 sends or generates a ticket for the ticketing server 304 to log the coordinates and the unique identifier for the location source 300. This way, invalid coordinates that are being forwarded to the mobile device and experience by the users can be immediately captured and properly stored in a database on the ticketing server 304.

The ticketing server 304, in turn, generates an error report that lists incorrect coordinates and the respective location source from where these coordinates originated. In one embodiment, the report is generated by using a common database output, such as a comma delimited text file. The error reports may be generated periodically or immediately after a new set of coordinates and location source identifier is recorded. The error reports are then sent to the operator in control of the location source. Using the unique identifiers listed on the error report, the operator can immediately identify the location source 300, e.g., the cellular tower responsible for providing the incorrect coordinates, and take necessary actions to load the correct coordinates onto the location source 300. Because each step in this process of capturing the coordinates, evaluating them, and reporting them to the operator is performed by a processor, either in the mobile device 100′, the location server 302, or the ticketing server 304, the response time for fixing the location source 300 can be relatively short. In other embodiments, this is a batch process using the ticketing database. In another embodiment, the process of updating an incorrect location source address is performed automatically without user involvement.

In one embodiment, the concept of this invention uses a common LBS client, e.g., a friend finder application, which is used by a large portion of the customer base of a mobile operator spread across the operator's service area, is modified to capture both network-provided location data and network element identifying information. The client sends the location data, e.g., GPS coordinates, to the server to receive location information associated with the location-based service. The location information is augmented by data points obtained by the client, e.g., base ID, network ID, that identifies the network elements providing the location information. Server side intelligence is then used to filter any incorrect information which, in turn, is used to generate targeted trouble tickets or error reports to address any incorrect information provided by the cellular network, i.e., the location source to a mobile LBS client, i.e., the mobile device. This can be accomplished using if, then, else logic within the system. For example, if location coordinates are in the U.S., the coordinates are returned to the application on the mobile device. Otherwise, if the coordinates are determined to be outside of the U.S., they are sent to the ticketing database and an error message is forwarded to the application instead. This helps service providers, such as MVNOs, save money and retain customers. In one embodiment, this approach can be coupled with rules or constraints such that if the software application does not include an error handling routine, a business rule dictates that the application provide the user with the wrong information.

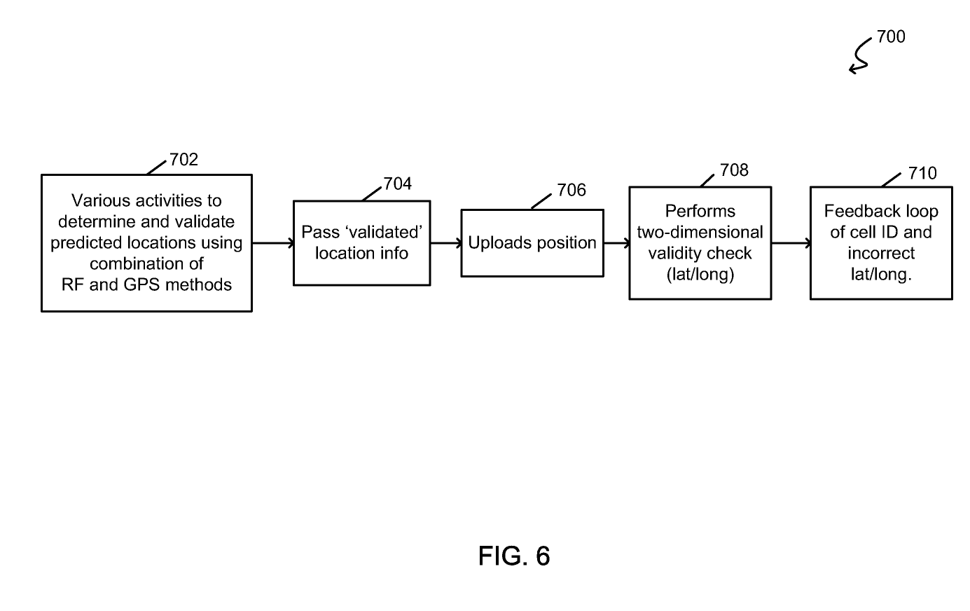

Turning now to FIG. 6, the method of detecting and reporting an error in location information can also be used in combination with existing network based validation process before the information is used by an application on the mobile device. One of the existing location validation methods uses a combination of RF and GPS methods to make sure the location data is not lost or modified before the data is received by the requesting mobile device (Step 702). When the user of the mobile device activates a location based application, such as FriendFinder, the location data is passed to the application (step 704). The data is then uploaded by the application to generate an output in response to the user request (step 706). For example, if the program FriendFinder is activated, the software uses the location data to indicate the user and his friends' current location on a map displayed on the mobile device. In various embodiments, depending on the application in use, the location data may need to be reformatted or processed before it can be read by the application.

Once the location data is uploaded into the program, a second validation process initiates (step 708). This step may be carried out by another program on a location server in communication with the mobile device, as discuss above. If the location data is in the format of a multi-dimensional coordinate (e.g., latitude/longitude), a multi-dimensional check is performed to verify that each component of the coordinate is valid. If the multi-dimensional check fails because the coordinate is invalid, the incorrect coordinate and the identifier of the location source are reported through a feedback loop to the operator of the location source (step 710). The feedback loop may include a ticketing server for storing information that relates to the incorrect coordinates.

Those of ordinary skill in the art will readily appreciate that mobile device 10 is exemplary only and that the present invention can operate within a number of different mobile devices. Furthermore, various embodiments of the present invention described above may be implemented at any level, ranging from hardware to application software and in any appropriate physical location or operating system.

Variations, modifications, and other implementations of what is described herein will occur to those of ordinary skill in the art without departing from the spirit and scope of the invention as claimed. Accordingly, the invention is to be defined not by the preceding illustrative description but instead by the spirit and scope of the following claims.

1. A method of increasing location based service accuracy by correcting location data associated with a fixed source, the method comprising:
receiving, on a mobile communication device, a first set of location data,
the first set of location data originating from the fixed source such that if the location data is accurate, a physical location of the mobile communication device can be determined,
the fixed source having a stored physical address which is updateable by an operator, wherein at least a portion of the first set of location data derives from the stored physical address;
determining whether the first set of location data is accurate; and
transmitting an error report to the operator if the first set of location data is inaccurate.

2. The method of claim 1 wherein the first location source is a cellular tower and the operator is a cellular network provider.

3. The method of claim 1 further comprising the step of obtaining a second set of location data from a second location source if the first set of location data is inaccurate.

4. The method of claim 3 wherein the second location source is a GPS.

5. A method of verifying location information received on a mobile device, the method comprising the steps of:
obtaining a set of location data from a location data provider;
forwarding the set of location data to a location server;
verifying, by the location server, whether the set of location data is valid; and
forwarding the set of location data to the mobile device if the set of location data is determined to be valid.

6. The method of claim 5 further comprising the step of logging the set of location data if the set of location data is determined to be invalid.

7. The method of claim 6 further comprising the step of logging an identifier of the location data provider.

8. The method of claim 5 further comprising the step of notifying the location data provider of the invalid set of location data.

9. The method of claim 5 further comprising the step of requesting correction of the set of location data from the location data provider.

10. The method of claim 5 wherein the set of location data is selected from the group consisting of latitude date, longitude data, altitude data, and a street address.

11. The method of claim 5 wherein the step of verifying further comprises performing a multi-dimensional validity check.

12. The method of claim 11 wherein the number of dimensions in the multi-dimensional validity check corresponds to the number of coordinates in the set of location data.

13. The method of claim 5 wherein the set of location data is cellular network data.

14. The method of claim 13 wherein the cellular network data relates to the Cell ID of a cellular tower.

15. The method of claim 5 further comprising the steps of converting the set of location data to a format suitable for displaying on the mobile device and displaying the converted set of location data on the mobile device.

16. A system for obtaining valid location information comprising:
a location source configured to provide a set of location data;
a mobile device configured to receive and display the set of location data from the location source;
a location server in communication with the mobile device and configured to validate the set of location data; and
a ticketing server in communication with the location server and configured to track the set of location data, the validity of the set of location data, and the location source by which the set of location data is provided,
wherein the mobile device displays the set of location data only after the set of location data is determined to be valid by the location server.

17. The system of claim 16 wherein the set of location data is selected from the group consisting of latitude data, longitude data, and altitude data.

18. The system of claim 16 wherein the location server performs a multi-dimensional validity check for each set of location data received by the mobile device.

19. The system of claim 18 wherein the number of dimensions in the multi-dimensional validity check corresponds to the number of coordinates in the set of location data.

20. The system of claim 16 wherein the set of location data is obtained using cellular network data.

21. The system of claim 20 wherein the cellular network data relates to the Cell ID of a cellular tower.

22. The system of claim 16 wherein the mobile device reformats the set of location data before displaying the reformatted set of location data.

23. The system of claim 16 wherein the location server informs the mobile device if the location server determines that the set of location data is invalid.
